(19) United States
(12) Patent Application Publication
(10) Pub. No.: US 2008/0118313 A1
(43) Pub. Date: May 22, 2008

(54) Milling insert and a milling insert tool for chip removing machining

(75) Inventors: Mats Jonsson, Hedemora (SE); Christer Jonsson, Hedemora (SE)

Correspondence Address: DRINKER BIDDLE & REATH (DC), 1500 K STREET, N.W., SUITE 1100, WASHINGTON, DC, 20005-1209, US

(73) Assignee: SECO TOOLS AB

(21) Appl. No.: 11/709,286

(22) Filed: Feb. 22, 2007

(30) Foreign Application Priority Data
Feb. 23, 2006 (SE) 0600406-3

(51) Int. Cl. B23G 5/18; B23G 5/00; B23B 27/14; B23C 5/06

(52) U.S. Cl. 407/42; 407/119; 409/65; 408/227

(57) ABSTRACT

A milling insert and a milling insert tool for chip removing machining. The milling insert includes at least two teeth. The milling insert has substantially a disc shape and includes a topside and an underside. The milling insert in its entirety is formed of cubic boron nitride.

This application claims priority under 35 U.S.C. § 119 to Sweden Patent Application No. 0600406-3, filed on Feb. 23, 2006, the disclosure of which is incorporated by reference herein in its entirety.

### FIELD OF THE INVENTION

The present invention relates generally to a rotatable milling insert, preferably for thread milling, including at least two teeth, and having substantially a disc shape. The present invention also relates to a thread-milling tool including a holder, which holds a milling insert having at least two teeth, the milling insert having substantially a disc shape.

### BACKGROUND OF THE INVENTION

In machining of workpieces of hard materials, such as white cast iron and hardened steel having a hardness from 45-70 HRC, it occurs that threads have to be made. The most common way to produce threads in such materials is to cut the thread in the material in a soft state by means of cemented carbide tools, i.e., before the material is hardened. The material can then be hardened, after which a concluding grinding may be carried out in order to compensate for changes in the geometry of the thread caused by the hardening. Certain materials may be relatively hard also before the hardening, wherein only low cutting speeds (for example 50 m/min) can be used and the service life of the tool becomes poor. Thus, the process for making threads in hard materials becomes both cost-consuming and time-consuming.

Another method of forming threads in hard materials is based on the use of the cutting material cubic boron nitride (CBN). CBN includes granules of cubic boron nitride and a special binder phase. CBN can machine materials in a hardened state at a relatively high cutting speed and feed without being, for example, chemically worn by the workpiece. Thereby, the cost and the time for the machining can be reduced by the fact that finishing is avoided. A known tool for such a machining comprises a plate of CBN soldered on a body of cemented carbide or steel. There are also indexable tools having CBN edges. Such a multi-edged soldered product is both cost-consuming and time-consuming to produce since soldering has to be effected on a plurality of different spots. The soldered seam of a soldered CBN tool may come loose at high machining temperatures. In case the temperature then is lowered by flushing cooling liquid on CBN tools during machining, other disadvantages occur, such as built-up-edge formation, which entails edge breakages, higher cutting forces and cost of the cooling liquid.

### SUMMARY OF THE INVENTION

An object of the present invention is to provide a milling insert and a milling insert tool that avoid the problems with prior art. Another object of the present invention is to provide a milling insert and a milling insert tool for economically advantageous cutting machining of hard metallic materials. Another object of the present invention is to provide a milling insert and a milling insert tool by means of which all machining can be effected in a set-up in a hardened state. Still another object of the present invention according to a preferred embodiment is to provide a milling insert and a milling insert tool having a stable attachment. Still another object of the present invention according to a preferred embodiment is to provide a regrindable milling insert.

In an embodiment, the invention provides a rotatable milling insert for thread milling, including at least two teeth. The milling insert has substantially a disc shape and includes a topside and an underside. The milling insert includes a center axis around which the milling insert is arranged to be rotated. The milling insert in its entirety is formed of cubic boron nitride.

In another embodiment, the invention provides a thread-milling tool including a holder, which holds a milling insert. The milling insert includes at least two teeth, and has substantially a disc shape and includes a topside and an underside. A center line of the milling insert has an extension perpendicular to a rotational axis of the holder. The milling insert includes a center axis around which the milling insert is arranged to be rotated. The milling insert in its entirety is formed of cubic boron nitride.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 shows a work piece for a milling insert according to an embodiment of the invention in plan view;

FIG. 2 shows the work piece in side view;

FIG. 3 shows the work piece in perspective view;

FIG. 4 shows a milling insert according to an embodiment of the invention in plan view;

FIG. 5 shows the milling insert in side view;

FIG. 6 shows the milling insert in perspective view;

FIG. 7 shows a part of the milling insert in side view in enlargement; and

FIG. 8 shows an alternative embodiment of a milling insert in side view in enlargement.

### DETAILED DESCRIPTION OF THE PREFERRED EMBODIMENTS

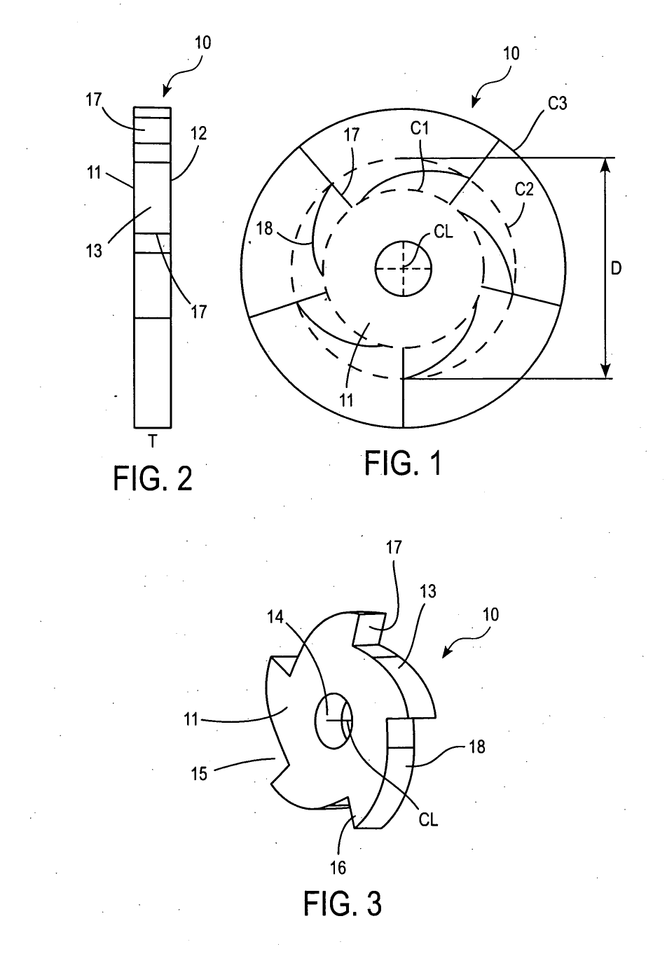

In FIGS. 1, 2 and 3, a work piece 10 is shown for a milling insert according to an embodiment of the invention. The work piece 10 consists exclusively of solid cubic boron nitride (CBN). The work piece 10 may be produced from a solid body of CBN by means of wire cutting. The work piece has the basic shape of a circular plate having a topside 11, an underside 12 as well as an edge surface 13 extending therebetween. The work piece has a thickness T, which is defined by the distance between the topside 11 and the underside 12. The thickness may be chosen in, for example, the interval of 2-5 mm. The work piece has a centrally placed, through-going hole 14. A number of recesses 15 are arranged at the periphery of the work piece, preferably produced by means of grinding. The number of recesses in the embodiment illustrated is five, but all from two to ten recesses is feasible. The recesses 15 form teeth 16 projecting from a circle C1. The circle C1 is concentric with the center axis CL of the work piece. Each tooth has a front surface 17 and a curved surface 18. The curved surface 18 may follow a path that may be described by a radius, the radius center of which is arranged so that the requisite clearance is attained. The radius may be greater than the thickness T, for example of the order of 7 mm. The pitch between the front surfaces 17 or the teeth may be irregular, for instance such as is shown by the outermost circle C3 in FIG. 1. Alternatively, the pitch between the front surfaces or the teeth may be regular. In the embodiment illustrated, the pitch between adjacent front surfaces as counted clockwise from the lower tooth in FIG. 1, is approximately as follows: 72°, 68°, 76°, 68° and 76°. The intention with an irregular pitch is to minimize vibrations when the completed milling insert is used. The middle circle C2 in FIG. 1 may indicate the imaginary greatest diameter D of the completed milling insert. The diameter D may be chosen in, for example, the interval of 15-30 mm. Thus, each tooth 16 projects a distance radially outside the circle C2 in order to achieve a machinery allowance.

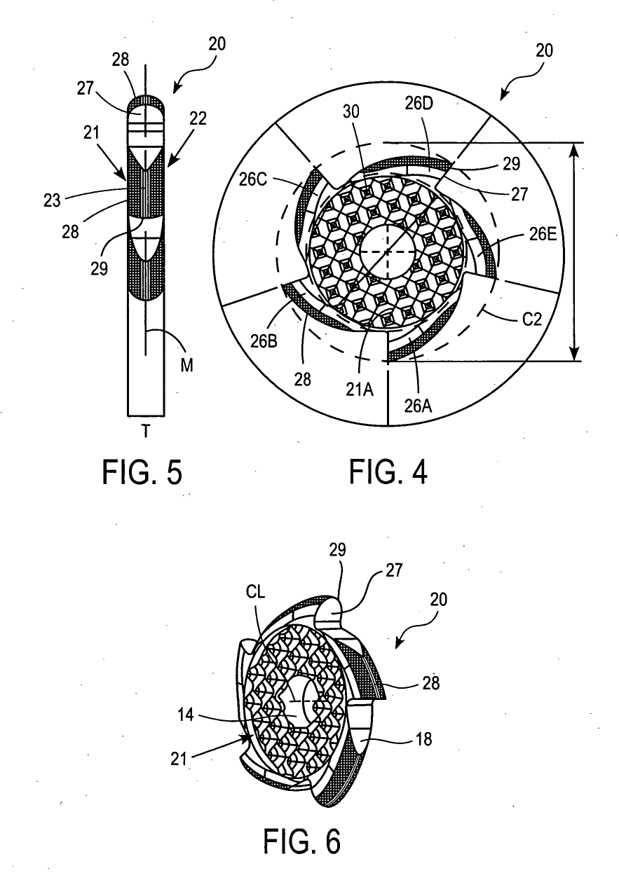

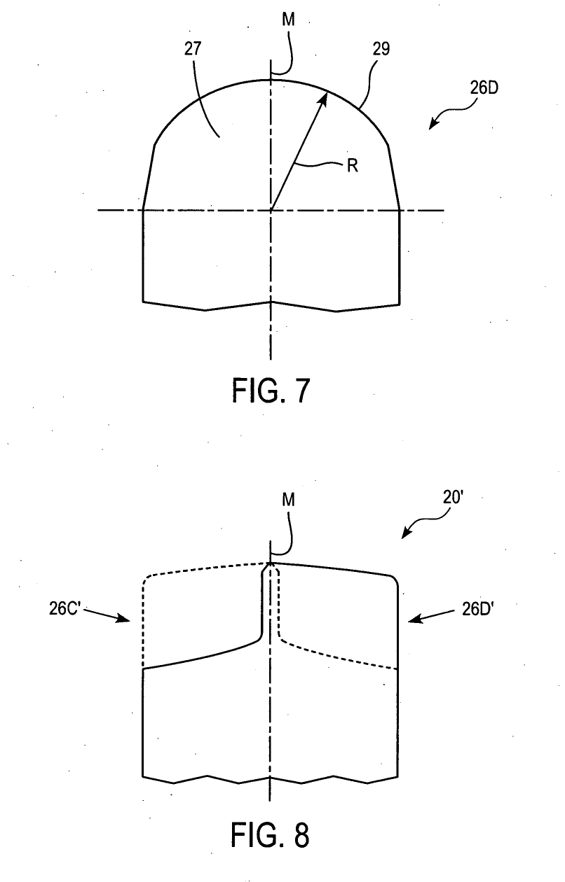

In FIGS. 4, 5 and 6, a milling insert 20 according to an embodiment of the invention is shown, manufactured from the work piece 10. The milling insert 20 shown is a rotatable thread-milling insert, which substantially has a disc shape. The milling insert 20 has a center axis CL around which the milling insert is arranged to be rotated during milling. The milling insert includes a topside 21 and an underside 22 as well as an edge surface 23 extending therebetween. At least one of the topside 21 and the underside 22 is adapted for form locking against a holder (not shown). In the embodiment illustrated, only the topside 21 has a profiled shape while the underside 22 is substantially planar. The edge surface 23 includes five teeth 26A, 26B, 26C, 26D and 26E, each one having a convex cutting edge 29. Each tooth 26A-26E includes a front surface or a rake face 27 and a clearance surface 28. The rake face 27 may be provided in a plane that intersects the center line CL of the milling insert or that intersects the hole 14. Parts of the curved surface 18 of the work piece remain in the milling insert 20. The cutting edge 29 is formed in the intersection between the rake face 27 and the clearance surface 28. The cutting edge 29 may be defined by a radius R of the rake face 27 (see FIG. 7), which in the embodiment is of the order of half the thickness T of the milling insert. The milling insert 20 has a center line M defined halfway between the sides 21 and 22. The center line M is preferably perpendicular to the center axis CL. Each tooth 26A-26E and respective cutting edge 29 are symmetrically arranged in relation to the center line M. Alternatively, each tooth and cutting edge may be asymmetrically arranged in relation to the center line M. Thus, the thread-milling insert 20 is formed in its entirety of cubic boron nitride. At least one of the sides 21 and 22 may, in the area between the hole 14 and the circle C2, include a support surface 21A provided with at least one driver arranged to transfer cutting forces to a holder of, for instance, the type disclosed in FIG. 2A of U.S. Pat. No. 6,146,060. The description of the holder disclosed in U.S. Pat. No. 6,146,060 is incorporated by reference herein. In the embodiment of the milling insert 20 shown in FIGS. 4-6, the driver is a honeycomb pattern, a number of peaks 30 having been formed by the fact that the side has been formed with two groove portions. Each groove portion covers substantially the entire support surface 21A and includes a number of identical channels or grooves separated from each other. The grooves of the groove portions have two main directions, which are perpendicular to each other. The groove portions intersect each other entirely, i.e., they do not end within the support surface except where a hole has been provided. Each groove is elongate as well as substantially V-shaped in cross-section. The groove portions may, for instance, be developed by means of laser burning. The teeth 26A-26E are preferably produced by grinding or electro-erosion (EDM). Upon wire cutting, an electrode in the form of a wire cuts through the work piece and, accordingly, creates a contour in a horizontal plane. The teeth of a thread-milling insert do not need to be identical but may have different designs, in the form of different cutting edges and profiles or set teeth. The number of teeth may vary from 2 to 10. An embodiment of the invention is directed to an internal thread-milling-cutter application. Furthermore, the insert may be formed in order to be possible to be reground several numbers of times with preserved profile, by the fact that the shape of the clearance surface, for example a radius, in radial cross section is kept substantially constant from the plane of the rake face 27 approximately up to the curved surface 18.

Alternatively, the cutting edge may be defined by a curve and/or one or more chamfers in a plane as illustrated in FIG. 8, where the tooth 26D′ of the milling insert 20′ includes at least one cutting chamfer and is asymmetrically arranged in relation to the center line M, a tooth 26C′ trailing in the direction of rotation being shown dashed as positioned in an opposite direction. The cutting edge may be convexly curved, along a curve that is partly circular, parabolic, elliptical or irregular.

The milling cutter tool is assembled by the support surface 21A of the milling insert 20 being pressed by hand against the front surface of the holder in any of four possible positions. Thereby, the directions of the grooves are aligned for the respective groove portion. The center line M of the milling insert 20 will then have an extension perpendicular to the rotational axis of the holder. A screw is inserted through the insert hole 14 and toward a threaded hole in the holder. Upon rotation of the screw via a key being in engagement with a key grip, the milling insert will be tightened against the front surface. Thus, the milling insert 20 is anchored to the holder. When the milling insert is to be exchanged, it is proceeded in the opposite way as upon the assembly, wherein the milling insert can be removed from the holder and be replaced. The coupling between the milling insert and the holder gives a distinct locking effect by means of form locking and allows transfer of high torques. In the use of the coupling, also tools having small diameters can be arranged in a stable way and allow a simple replacement of milling inserts. The thread in the hard workpiece is suitably produced by means of circular interpolation or spiral interpolation. The workpiece has then a recess or a projection in or on which a thread is milled.

The milling insert according to the present invention solves machining problems in the production of hard products or hardened details. The tool according to the invention entails that all machining can be carried out in one set-up, in a hardened state. Furthermore, the milling insert is regrindable a number of times with preserved profile, and therefore the milling-insert cost to the user is reduced.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

What is claimed is:

1. A rotatable milling insert for thread milling, comprising at least two teeth, the milling insert having substantially a disc shape and including a topside and an underside, wherein the milling insert includes a center axis around which the milling insert is arranged to be rotated, and wherein the milling insert in its entirety is formed of cubic boron nitride.

2. The milling insert according to claim 1, wherein the milling insert includes a center line arranged perpendicularly to the center axis, and wherein each tooth includes a cutting edge, the cutting edge being symmetrically arranged in relation to the center line.

3. The milling insert according to claim 1, wherein the milling insert includes a center line arranged perpendicularly to the center axis, and wherein each tooth includes a cutting edge, the cutting edge being asymmetrically arranged in relation to the center line.

4. The milling insert according to claim 1, wherein each tooth includes a convex cutting edge, which is defined by a radius, wherein the milling insert has a thickness, and wherein the radius is of the order of half the thickness of the milling insert.

5. The milling insert according to claim 3, wherein a pitch between the teeth is irregular.

6. The milling insert according to claim 3, wherein a pitch between the teeth is regular.

7. The milling insert according claim 1, wherein at least one of the topside and the underside is adapted for form locking against a holder.

8. A thread-milling tool comprising a holder, which holds a milling insert, the milling insert including at least two teeth, the milling insert having substantially a disc shape and including a topside and an underside, a center line of the milling insert having an extension perpendicular to a rotational axis of the holder, wherein the milling insert includes a center axis around which the milling insert is arranged to be rotated, and wherein the milling insert in its entirety is formed of cubic boron nitride.

9. The thread-milling tool according to claim 8, wherein each tooth includes a cutting edge, the cutting edge being symmetrically arranged in relation to the center line.

10. The thread-milling tool according to claim 8, wherein each tooth includes a cutting edge, the cutting edge being asymmetrically arranged in relation to the center line.
